(19) United States
(12) Patent Application Publication
(10) Pub. No.: US 2008/0131664 A1
(43) Pub. Date: Jun. 5, 2008

(54) ROOFING SHINGLE HAVING AGGLOMERATED MICROORGANISM RESISTANT GRANULES

(76) Inventors: Yihsien H. Teng, Westerville, OH (US); Marc B. Kuttler, Lancaster, OH (US); Lawrence J. Grubka, Westerville, OH (US)

Correspondence Address: OWENS CORNING, 2790 COLUMBUS ROAD, GRANVILLE, OH, 43023, US

(21) Appl. No.: 11/933,334

(22) Filed: Oct. 31, 2007

Related U.S. Application Data
(63) Continuation-in-part of application No. 11/493,748, filed on Jul. 26, 2006.

(51) Int. Cl. D06N 7/04; B05D 7/00; B32B 5/16

(52) U.S. Cl. 428/144; 427/212; 428/403

(57) ABSTRACT

An agglomerated microorganism resistant granule includes a base material having microorganism resistant characteristics and a filler material mixed with the base material. The filler material is configured to erode over time. The erosion of the filler material leaves voids and irregular surfaces in the agglomerated base material.

### TECHNICAL FIELD

This invention relates to roofing materials. More particularly, the invention pertains to asphalt roofing shingles having microorganism resistant granules.

### BACKGROUND OF THE INVENTION

Asphalt-based roofing materials, such as roofing shingles, are installed on the roofs of buildings to provide protection from the weather. Typically, the roofing material is constructed of a substrate, an asphalt coating on the substrate, and a surface layer of mineral granules embedded in the asphalt coating.

In some climates with moderate to high humidity, algae, fungi, and other types of microorganisms often grow on the exposed surfaces of an untreated roofing material. This algal and/or fungal growth initially leads to a discoloring of the exposed roofing material surfaces and ultimately to dark streaks that may cover a majority of the roof. The discoloration generally occurs over a period of years. For example, the discoloration may become visible during the second or third year after the untreated roofing shingles have been applied in warm and humid climates. The discoloring is particularly noticeable and unsightly on white or light-colored roofing materials, which are often used in humid climates because of their aesthetic and sun reflectivity properties.

To combat algae and/or fungi growth, it is generally known to include microorganism resistant granules on the exposed surface of the roofing material. One type of microorganism resistant granule is a granule coated with a glass or ceramic coating containing an algicidal active ingredient, such as for example copper or copper compounds. When wetted by rain or dew, the copper leaches out from the roofing material and acts as an algicide and/or a fungicide to inhibit the growth of the microorganisms including algae and/or fungi. Other types of granules can include granules purely of an algicidal active ingredient, such as for example pure copper or copper compound granules.

It would be desirable to optimize the characteristics and composition of the microorganism resistant granules for improved performance and cost effectiveness.

### SUMMARY OF THE INVENTION

According to this invention there is provided an agglomerated microorganism resistant granule. The agglomerated microorganism resistant granule has a base material having microorganism resistant characteristics and a filler material mixed with the base material. The filler material is configured to erode over time. The erosion of the filler material leaves voids and irregular surfaces in the agglomerated base material.

According to this invention there is also provided a method of manufacturing an agglomerated microorganism resistant granule. The method comprising the steps of providing a base material having microorganism resistant characteristics, providing a filler material configured to erode over time, mixing the base material and filler material to form a mixture, compacting and densifying the mixture, heating the mixture in an atmosphere to a temperature sufficient for sintering the base material and filler material thereby forming a sintered mixture and forming the sintered mixture into agglomerated microorganism resistant granules.

According to this invention there is also provided a microorganism resistant roofing shingle. The shingle includes a prime region that is normally exposed when the roofing shingle is installed on a roof. The exposed portion of the roofing material comprises a substrate coated with a coating. The coating includes an upper surface that is positioned above the substrate when the roofing material is installed on the roof. Agglomerated microorganism resistant granules are applied to the upper surface of the coating. The agglomerated microorganism resistant granules have a base material and a filler material. The base material has microorganism resistant characteristics. The filler material is configured to erode over time. The erosion of the filler material leaves voids and irregular surfaces in the agglomerated base material.

Various advantages of this invention will become apparent to those skilled in the art from the following detailed description of the invention, when read in light of the accompanying drawings.

### BRIEF DESCRIPTION OF THE DRAWINGS

FIG. 1 is a perspective view of a roofing shingle including agglomerated microorganism resistant granules according to the invention.

FIG. 2 is a cross-sectional view of the prime region of the roofing shingle taken along Line 2-2 of FIG. 1.

FIG. 3 is an enlarged front elevational view of an agglomerated microorganism resistant granule of the invention of FIG. 1.

FIG. 4 is an enlarged front elevational view of the agglomerated microorganism resistant granule of FIG. 3 after filler material has eroded away.

FIG. 5 is a schematic elevational view of a portion of an apparatus for making agglomerated microorganism resistant granules according to the method of the invention.

### DETAILED DESCRIPTION OF THE INVENTION

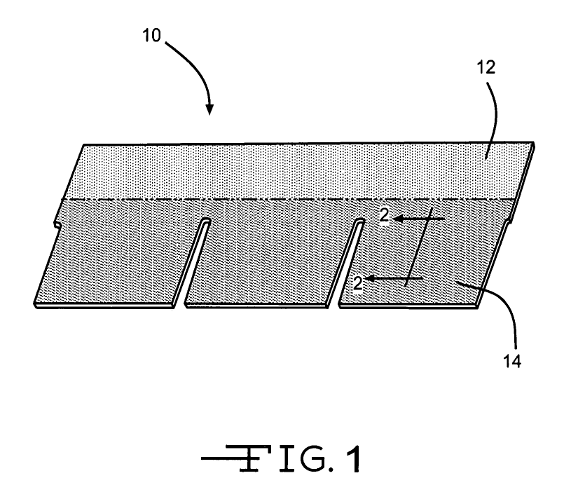

Referring now to the drawings, FIG. 1 shows a microorganism resistant roofing shingle, indicated generally at 10, according to the invention. While the illustration shows a strip shingle, one skilled in the art appreciates the present invention applies to a variety of roofing products, including laminate shingles, rolled roofing or other products.

The illustrated shingle 10 includes a headlap region 12 and a prime region 14. The headlap region 12 of the shingle 10 is the portion of the shingle 10 that is covered by adjacent shingles when the shingle 10 is installed upon a roof. The prime region 14 of the shingle 10 is the portion of the shingle 10 that remains exposed when the shingle 10 is installed upon a roof. The prime region 14 is the portion of the shingle 10 where growth of microorganisms, such as for example fungi and algae, may occur.

The shingle 10 may have any suitable dimensions. The shingle 10 may also be divided between the headlap region 12 and the prime region 14 in any suitable proportion. For example, a typical residential roofing shingle 10 is approximately 36 inches (91.5 cm) wide by 12 inches (30.5 cm) high, with the height dimension being divided between the headlap region 12 and the prime region 14. In one embodiment, the height of the headlap region 12 is approximately 2 inches (5.1 cm) greater than the height of the prime region 14. Alternatively, the height of the headlap region 14 can be more or less than 2 inches greater than the height of the prime region 12.

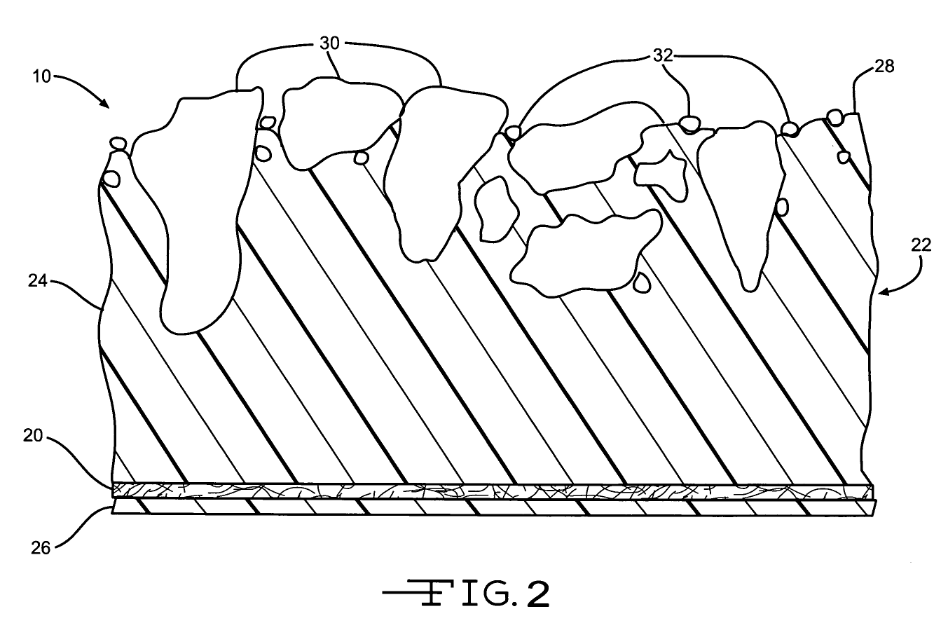

FIG. 2 illustrates the composition of the shingle 10 according to the invention. Generally, the shingle 10 consists of a substrate 20 that is coated with a coating, indicated generally at 22. An application of prime granules 30 and agglomerated microorganism resistant granules 32 is applied to the coating 22. The term “microorganism”, as used herein, is meant to include algae and/or fungi and/or similar microorganisms that can grow on a roofing material.

The substrate 20 can be any material suitable for providing the supporting structure in a roofing material, such as for example fiberglass mat or organic felt. The coating 22 can be made from any material(s) suitable for use as a roofing material coating, such as for example asphalt or other bituminous material, polymer, or combinations of asphalt and polymer. The coating 22 can contain any suitable filler(s) and/or additive(s). As shown in FIG. 2, the coating 22 includes an upper region 24 and a lower region 26. The upper region 24 includes an upper surface 28. The upper region 24 and upper surface 28 are positioned above the substrate 20 when the roofing material is installed on a roof. The lower region 26 is positioned below the substrate 20 when the roofing material is installed on a roof.

As indicated above, an application of prime granules 30 and granules 32 is applied to the top surface 28 of the coating 22. The prime granules 30 can be any suitable material typically used in roofing material construction, such as for example granite, ceramic coated granite, or other stone or ceramic coated stone material. In one embodiment, the prime granules 30 and the granules 32 can be mixed together prior to the application to the top surface 28 of the coating 22. In this embodiment, the mixture of the prime granules 30 and the granules 32 is applied to the top surface 28 of the coating 22 in any suitable manner, such as that described in copending U.S. application Ser. No. 11/493,748, filed Jul. 26, 2006, which is a continuation-in-part of co-pending U.S. Utility application Ser. No. 11/066,644, filed Feb. 25, 2005, the disclosures of which are incorporated herein by reference in their entirety. As an example, the mixture of the prime granules 30 and the granules 32 may be applied in a single application. The single simultaneous application of the prime granules 30 and the granules 32 can be completed using existing metering, mixing and application equipment. In another example, the mixture of the prime granules 30 and the granules 32 may be applied in a series of applications, such as blend drops and background granules, as is common practice when multiple colors of prime granules 30 are applied to the shingle 10. In yet another embodiment, the prime granules 30 and the granules 32 may be applied separately in any suitable manner. As one example, the granules 32 may be applied after the application of the prime granules 30. As another example, the granules 32 may be applied prior to the application of the prime granules 30. The granules 32 can be applied by any suitable mechanism, such as with a gravimetric or volumetric feeder. In the illustrated embodiment, the granules 32 are blended with the prime granules 30 at a weight percentage in a range from about 0.2% to about 20.0%. Alternatively, the granules 32 can be blended with the prime granules 30 at a weight percentage less than 0.2% or more than 20%

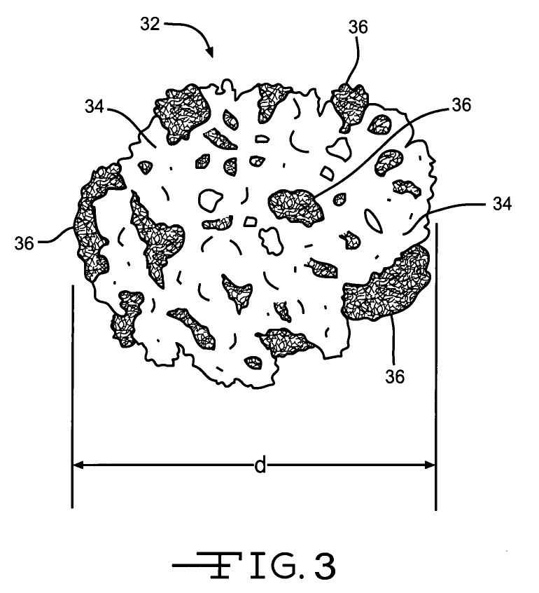

Referring now to FIG. 3, an agglomerated granule 32 is shown. The granule 32 includes base material 34, filler material 36, voids 38 and irregular surfaces 40. The term “agglomerated” as used herein, is defined to mean a collection or gathering of individual particles bonded together into a larger cluster or mass. With specific reference to the agglomerated granules 32, the term “agglomerated” is defined to mean a gathering of individual particles of the base material 34 and individual particles of the filler material 36 bonded together into the larger granules 32. The term “void”, as used herein, is defined to mean a gap, an empty space or a hole. The term “irregular surface”, as used herein, is defined to mean a surface having undulations, bulges, protrusions and/or sharp edges. As shown in FIG. 3, the voids 38 and the irregular surfaces 40 provide access for the dissolving agents to filler material within internal areas of the granules 32.

In the illustrated embodiment, the base material 34 is a metal or metal alloy that includes at least one microorganism resistant active ingredient. The at least one active ingredient of the granules 32 provides the appropriate algicidal properties desired for the microorganism resistant shingle 10. In one embodiment, the microorganism resistant active ingredient of the granules 32 includes copper. Alternatively, the microorganism resistant active ingredient can be copper alloys including such as for example zinc, tin, aluminum, and silicon.

As shown in FIG. 3, the filler material 36 is preferably a soluble inorganic material. In the illustrated embodiment, the filler material 36 is configured to be soluble when exposed to natural weathering conditions or a dissolving agent. One example of a dissolving agent is rain water running over an installed shingle 10. Other examples of dissolving agents include for example dew, atmospheric gases and solar radiation. In the illustrated embodiment, the filler material 36 is an inexpensive material, such as for example a borate-based material including ulexite, colemanite, or borax. An inexpensive filler material 36 provides the advantage of reducing the cost of the materials used in the shingle 10. In another embodiment, the filler material 36 can be other inexpensive soluble materials, including for example chlorides, carbonates, fluorides, or other inorganic materials. Alternatively, insoluble materials may also be used as filler material 36. Examples of insoluble materials include fly ash, coal slag, recycled glass, gypsum, limestone pumice, dolomite, expanded perlite shale, diatomaceous earth, sand, metal refining slags, etc.

In one embodiment, the filler material 36 can include particles that are active in resisting microorganisms. Alternatively, the filler material 36 can be inert.

In one embodiment, the base material 34 comprises approximately 50 percent, by weight, of the weight of the granules 32. In another embodiment, the weight of the base material 34 compared to the total weight of the granule 32 can be in a range from about 20 percent to about 90 percent.

As shown in FIG. 3, the granules 32 have a major dimension d. In one embodiment, the major dimension d of the granules 32 is approximately 200 microns. In another embodiment, the major dimension d of the granules 32 can be in a range from about 200 micron to about 1500 microns.

The filler material 36 is configured to provide several benefits. Erosion of the filler material 36 exposes additional areas of the base material 34 to weathering agents, thereby increasing the porosity of the particle 32 and enlarging the surface area of the active ingredients.

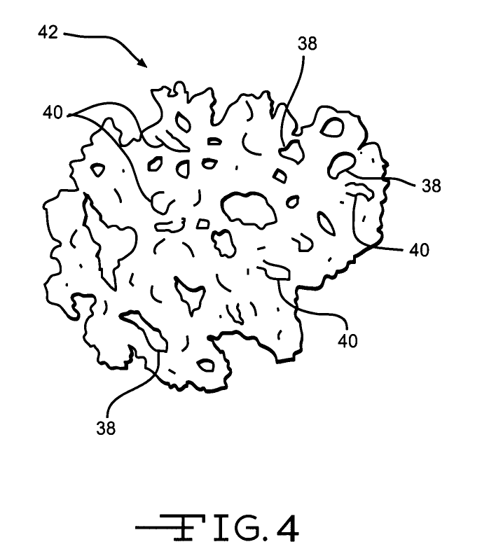

As described above, an installed shingle 10 is exposed to natural weathering conditions and dissolving agents. Accordingly the shingle 10 and the granules 32 age with time. As shown in FIG. 4, over a period of time, the filler material 36 preferably dissolves and erodes relatively more quickly than the base material 34, leaving the base material 34, voids 38 and irregular surfaces 40. The base material 34, voids 38 and irregular surfaces 40 form agglomerated base material granules 42, resulting in a structure which may be referred to as a “skeletal structure”.

Referring again to FIG. 4, as a result of the plurality of voids 38 and the irregular surfaces 40, the agglomerated base material granules 42 have a large surface area. The large surface area may provide one or more benefits such as an optimized leach rate of the microorganism resistant ingredient, increased protection longevity, a reduced amount of base material required for each granule 32 and a reduced quantity of required granules 32. The reduction in the amount of base material required for each granules 32 and a reduction in the quantity of required granules 32 results in a less costly shingle 10.

The large surface area of the agglomerated base material granules 42 may be characterized by measurements of the specific surface area. The specific surface area of the agglomerated base material granules 42 can be measured by BET Isotherm Analysis or any other suitable method. BET Isotherm Analysis allows for the calculation of specific surface area for structures having multiple layers, such as for example the agglomerated base material granules 42. Highly irregular granules, having a plurality of voids and irregular surfaces, usually have large specific surface areas compared to normally shaped granules. In the illustrated embodiment, the agglomerated base material granules 42 have a specific surface area of about 0.2 m²/g. In another embodiment, the specific surface area of the agglomerated base material granules 42 can be in a range from about 0.05 m²/g to about 1 m²/g. One skilled in the art appreciates that appropriate specific surface area may be tailored to suit the application.

Referring again to the illustrated embodiment shown in FIG. 3, the granules 32 have pre-existing porosity in a range from about 10 vol % to about 70 vol %. In another embodiment, the pre-existing porosity of the granules 32 can be more than 70 vol % or less than 10 vol %.

Referring again to the illustrated embodiment shown in FIG. 2, the granules 32 have a bulk density in a range from about 1.1 g/cc to about 2.5 g/cc. The prime granules 30 have a bulk density in a range from about 1.3 g/cc to about 1.9 g/cc. Bulk density is measured using ASTM testing procedure B212-99. ASTM B212-99 is a standard test method for measuring the apparent density of free-flowing metal powders using the Hall Flowmeter Funnel. Since the bulk density of the granules 32 is relatively close to the bulk density of prime granules 30, the granules 32 can be mixed in blends, accordingly the application of the blends can be accomplished while maintaining consistent material handling characteristics.

Referring again to FIGS. 1 and 2, the shingle 10 contains a suitable amount of granules 32 to provide microorganism resistance as the installed shingle 10 weathers over time. Shingles 10 may be manufactured to different specifications to provide the duration of protection desired. In the illustrated embodiment, the desired duration of the microorganism resistance of the shingle 10 is about ten years. In another embodiment, the desired duration of the microorganism resistance of the shingle 10 can be more or less than ten years.

The granules 32 provide microorganism resistance over time because the microorganism inhibiting ingredient of the granules 32 is leached, or drawn out, from the shingle 10 over time. A prescribed leach rate provides the shingle 10 with microorganism resistant characteristics without prematurely depleting the granules 32 from the shingle 10. The leach rate of the microorganism inhibiting ingredient can be measured using the “dew test”. The dew test can be carried out in either a natural weathering environment or a simulated weathering environment. In a natural weathering environment, the dew test analyzes the concentration of the algae-inhibiting ingredient of the metallic particles 30 dissolved in dew formed on the roofing shingles 10 during natural weathering. When weather permits, dew forms on the roofing material and runs off into a collection trough. The dew samples are collected in the morning hours (i.e. generally between 7:00 a.m. and 8:00 a.m.) before the dew evaporates from the roofing shingles 10. The dew samples are collected from roofing shingles 10 that have been naturally weathered for a minimum of 6 months, and at least 10 collections of dew samples are collected and analyzed to determine the average algae inhibiting ingredient concentration in the dew runoff. The dew runoff is preferably analyzed by inductively-coupled plasma analysis (ICP) with a detection limit to at least 0.1 parts per million. In one embodiment, the leach rate of copper-based base material 34 in the granules 32 for the ten year microorganism resistant shingle 10 is within a minimum range of from about 0.3 parts per million to about 1.0 parts per million as measured in dew runoff collected from the natural weathering environment. It should be appreciated that the leach rate may be proportionally adjusted depending upon the region of installation and desired duration of the microorganism resistance of the shingle 10 and may be significantly higher if desired, but the recited ranges are commercially beneficial.

Since the cost of the base material 34 can be more expensive than the cost of prime granules 30, the quantity of granules 32 contained on the shingle 10 can contribute significantly to the overall cost of the shingle 10. One advantage of the illustrated embodiment of the invention is that the quantity of granules 32 required on the shingle 10, and the associated base material 34, may be minimized as a result of a large surface area of the agglomerated base material granule 42, while still achieving the desired duration of microorganism resistance for the shingle 10.

In the illustrated embodiment shown in FIG. 2, the granules 32 are applied to the roofing material in an amount within the range of from about 0.05 pound (22.7 g) to about 0.20 pound (90.8 g) per square. In another embodiment, the granules 32 can be applied to the roofing material in an amount in a range from about 0.05 pound (22.7 g) per square to about 0.4 pound (181.6 g) per square of shingles 10, depending on the chemistry and characteristics of the agglomerated granules 32, the application process and the region of installation. The term “square” is well recognized in the art and refers to the amount of shingles 10 necessary to cover one hundred square feet (9.29 square meters) of roof surface. It will be appreciated that the amount of granules 32 required per square may be proportionally adjusted to any other suitable amount depending upon the microorganism inhibiting ingredient used and/or the desired duration of microorganism resistance for the shingle 10.

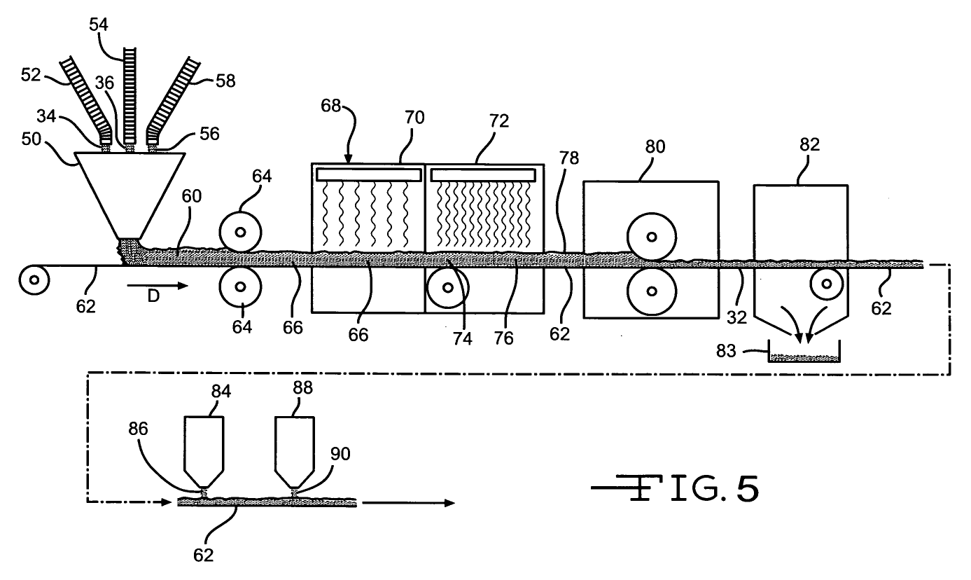

The granules 32 can be manufactured by continuous or batch methods. One example of a method to manufacture granules 32 is a continuous sintering method as shown in FIG. 5. Alternatively, other methods of manufacturing, including for example batch methods, the granules 32 can be used.

As shown in FIG. 5, the agglomerated microorganism resistant granule manufacturing operation involves passing a mixture of the base material 34 and the filler material 36 through a series of manufacturing operations.

A mixture of the base material 34 and the filler material 36 is formed within a rotary blender 50. In the illustrated embodiment, the base material 34 is cuprous oxide powder. Alternatively, the base material 34 can be another material, such as for example cupric oxide, metallic copper, other suitable metal such as zinc, tin, aluminum, and silicon, or an alloy powder. The base material 34 is supplied to the rotary blender 50 by a base material supply hose 52. In another embodiment, the base material 34 can be supplied by other suitable devices. In the illustrated embodiment, the filler material 36 is supplied to the rotary blender 50 by a filler material supply hose 54. In another embodiment, the filler material 36 can be supplied by other suitable devices.

Optionally, a blending fluid 56 can be supplied to the rotary blender 50 and mixed with the base material 34 and the filler material 36. The blending fluid 56 is configured to facilitate downstream processing operations. In one embodiment, the blending fluid 56 is water. In another embodiment, the blending fluid 56 can be other materials sufficient to facilitate downstream processing operations. In the illustrated embodiment, the optional blending fluid 56 is supplied to the rotary blender 50 by an optional blending fluid supply hose 58. In another embodiment, the optional blending fluid 56 can be supplied by other suitable devices.

The rotary blender 50 is configured to mix the base material 34, the filler material 36 and the optional blending fluid 56 into a mixture 60. The rotary blender 50 can be any suitable device or mechanism for mixing the base material 34, the filler material 36 and the optional blending fluid 56 into a mixture 60. The mixture 60 is fed onto a moving conveyer 62 and moved in machine direction D. The mixture 60 can be moved at any suitable speed.

In the illustrated embodiment, the mixture 60 is passed through forming rollers 64. The forming rollers 64 are configured to compact and densify the mixture 60 thereby producing a formed mixture 66. The forming rollers 64 are configured to supply an adjustable pressure to the mixture 60 in a range from about 1 psi to about 5,000 psi. In another embodiment, the mixture 60 can be compacted and densified by other mechanisms and other processes, such as for example mechanical pressing, agglomeration, extrusion, vibration and pelletizing. In yet another embodiment, the formed mixture 66 can be formed into discrete forms such as for example cakes or pellets. In yet another embodiment, the mixture 60 can be passed to further downstream operations without compaction and without densification.

The formed mixture 66 is moved downstream into a furnace 68. In the embodiment shown in FIG. 5, the furnace 68 includes a low temperature section 70 and a high temperature section 72. In another embodiment, the furnace 68 may include other furnace sections having other heat settings. The formed mixture 66 is moved to the low temperature section 70 for preheating. In the illustrated embodiment, the low temperature section 70 is configured to heat the formed mixture 66 in an oxidizing atmosphere such that carbon and organic residues are removed from the formed mixture 66. Alternatively, the low temperature section 70 can be configured to heat the formed mixture in another type of atmosphere. In one embodiment, the formed mixture 66 is heated, in the low temperature section 70, to a minimum temperature of 400° C. In another embodiment, the formed mixture 66 can be heated to other temperatures sufficient to remove carbon and organic residues from the formed mixture 66. Heating the formed mixture 66 in the low temperature section 70 produces an oxidized mixture 74. While the illustrated embodiment shows a low temperature section 70 configured to heat the formed mixture 66 in an oxidizing atmosphere such that carbon and organic residues are removed from the formed mixture 66, it should be understood that the low temperature section 70 of the furnace 68 is an optional process and in another embodiment, the formed mixture 66 can be moved directly into the high temperature section 72 of the furnace 68.

Referring again to FIG. 5, the oxidized mixture 74 is moved from the low temperature section 70 to the high temperature section 72 of the furnace 68. The high temperature section 72 is configured to heat the oxidized mixture 74 to a high temperature thereby reducing the base material 34 and simultaneously sintering the oxidized mixture 74 in a reducing atmosphere. The term “sinter” as used herein, is defined to mean a manufacturing operation whereby metal particles are joined together without fusion, by the process of heating. In the illustrated embodiment, the oxidized mixture 74 is heated, in the high temperature section 72, to a temperature in a range from about 1200° F. to about 1800° F. In another embodiment, the oxidized mixture 74 can be heated to other temperatures sufficient to reduce the base material 34 and simultaneously sinter the oxidized mixture 74. During the high temperature sintering process, the atmosphere within the high temperature section 72 is composed of gases that facilitate the reduction of base material 34 and sintering of the oxidized mixture 74. In the illustrated embodiment, the atmosphere is composed of hydrogen. In another embodiment, the atmosphere can have other compositions, such as for example a mixture of hydrogen and nitrogen, sufficient to facilitate the reduction of base material 34 and sintering of the oxidized mixture 74. Heating the oxidized mixture 74 in the high temperature section 72 produces a sintered mixture 76.

In the illustrated embodiment, the sintered mixture 76 exits the high temperature section 72 to cool. In one embodiment, the furnace 68 can contain a cooling section that allows the sintered mixture 76 to cool to a lower temperature at a controlled rate in an atmosphere that avoids oxidation of the sintered mixture. Referring again to FIG. 5, the cooled sintered mixture 76 becomes a sintered agglomerate block 78. In another embodiment, the cooled sintered mixture 76 can be formed into other shapes, such as for example cakes. In another embodiment, the sintered mixture 76 can be cooled using other suitable processes.

The agglomerate block 78 is moved to a crushing mechanism 80. The crushing mechanism 80 is configured to crush the agglomerate block 78 into individual agglomerated granules 32. In the illustrated embodiment, the crushing mechanism 80 is a rotary crusher. In another embodiment, the crushing mechanism 80 can be other mechanisms, such as for example grinders or mills, sufficient to crush the agglomerate block 78 into individual agglomerated granules 32.

Referring again to FIG. 5, the granules 32 are moved to an optional screening operation 82. The screening operation 82 is configured to distribute the granules 32 into like sizes. The screening operation 82 can be any suitable operation, such as for example a sieve distribution, sufficient to distribute the granules 32 into like sizes. The granules 32 of the desired size are moved downstream on conveyer 62 while granules 32 of an undesired size are removed to hopper 83 for further processing.

Optionally, the granules 32 can be processed with additional manufacturing operations. In the illustrated embodiment, the granules 32 pass beneath a binder applicator 84. In one embodiment, the binder applicator 84 is configured to apply a liquid binder 86 to the granules 32, such that a continuous solid binder layer is formed around the granules 32 and the granules 32 are strengthened subsequent to the curing of the binder. In the illustrated embodiment, the solid layer is porous and configured to adjust the leach rate of the granules 32. In one embodiment, the binder 86 is an emulsified polymer binder. In another embodiment, the binder 86 can be other binders, such as for example colloidal silica, sodium silicate or ethyl silicate, sufficient to strengthen and adjust the leach rate of the granules 32. In the illustrated embodiment, the binder applicator 84 is a spray applicator. In another embodiment, the binder applicator 84 can be other mechanisms, such as for example drop applicators, sufficient to apply the binder 86 to the granules 32.

Alternatively, if a binder 86 is not applied to the granules 32, the granules 32 pass beneath an oil applicator 88. The oil applicator 88 is configured to apply a small amount of oil 90 to the granules 32 to control such, such that the granules 32 are ready for application to the shingles 10. In the illustrated embodiment, the oil applicator 88 is a spray applicator. In another embodiment, the oil applicator 88 can be other mechanisms, such as for example drop applicators, sufficient to apply the oil 90 to the granules 32.

While the illustrated process shown in FIG. 5 can be used for manufacturing granules 32, as noted above other manufacturing methods can be used. One example of another method of manufacturing the granules 32 is a method of agglomerating the base material onto a granule or onto a shingle using a thermal spray process (also known as flame spray). A thermal spray process involves spraying at least one base material having metal algaecides, such as copper or zinc, in the form of droplets of molten metal directly onto the surface of the shingle or onto the surface of the prime granules. The base materials solidify and adhere onto the applied surface. The applied base materials provide the desired microorganism resistance.

The principle and mode of operation of this invention have been described in its preferred embodiments. However, it should be noted that this invention can be practiced otherwise than as specifically illustrated and described without departing from its scope.

1. An agglomerated microorganism resistant granule comprising:
a base material having microorganism resistant characteristics; and
a filler material mixed with the base material, the filler material configured to erode over time;
wherein the erosion of the filler material leaves voids and irregular surfaces in the agglomerated base material.

2. The agglomerated microorganism resistant granule of claim 1 wherein the granule is formed by sintering.

3. The agglomerated microorganism resistant granule of claim 1 wherein the base material is a copper alloy.

4. The agglomerated microorganism resistant granule of claim 1 wherein the weight of the base material compared to the weight of the granule is in a range of from about 20 percent to about 90 percent.

5. The agglomerated microorganism resistant granule of claim 1 wherein the filler material is a borate material.

6. The agglomerated microorganism resistant granule of claim 1 wherein the filler material includes a microorganism resistant material.

7. The agglomerated microorganism resistant granule of claim 1 wherein the filler material is water soluble.

8. The agglomerated microorganism resistant granule of claim 7 wherein the filler material is ulexite.

9. The agglomerated microorganism resistant granule of claim 1 wherein the filler material is insoluble.

10. The agglomerated microorganism resistant granule of claim 8 wherein the filler material is fly ash.

11. The agglomerated microorganism resistant granule of claim 1 wherein the granules have a pre-existing porosity in a range from about 10 vol % to about 70 vol %.

12. The agglomerated microorganism resistant granule of claim 1 wherein the granule has a specific surface area in a range of about 0.05 m²/g to about 1 m²/g.

13. The agglomerated microorganism resistant granule of claim 1 wherein the granule has a major dimension in a range from about 200 microns to about 1500 microns.

14. The agglomerated microorganism resistant granule of claim 1 wherein the granules have a bulk density in a range from about 1.1 g/cc to about 2.5 g/cc.

15. A method of manufacturing an agglomerated microorganism resistant granule, the method comprising the steps of:
providing a base material having microorganism resistant characteristics;
providing a filler material configured to erode over time;
mixing the base material and filler material to form a mixture;
compacting and densifying the mixture;
heating the mixture in an atmosphere to a temperature sufficient for sintering the base material and filler material thereby forming a sintered mixture; and
forming the sintered mixture into agglomerated microorganism resistant granules.

16. The method of claim 15 wherein the mixture is compacted prior to heating.

17. The method of claim 15 wherein the mixture is preheated in an oxidizing atmosphere.

18. The method of claim 15 wherein the sintered mixture is cooled in an oxidizing atmosphere.

19. The method of claim 15 wherein the agglomerated granules are coated with a binder.

20. The method of claim 15 wherein the filler material includes a microorganism resistant material.

21. The method of claim 15 wherein the filler material is water soluble.

22. The method of claim 15 wherein the granule has a specific surface area in a range of about 0.05 m²/g to about 1 m²/g.

23. The method of claim 15 wherein the agglomerated microorganism resistant granules have a major dimension in a range from about 200 micron to about 1500 microns.

24. A microorganism resistant roofing shingle including a prime region that is normally exposed when the roofing shingle is installed on a roof, the exposed portion of the roofing material comprising:
a substrate coated with a coating, the coating including an upper surface that is positioned above the substrate when the roofing material is installed on the roof; and
agglomerated microorganism resistant granules applied to the upper surface of the coating, the agglomerated microorganism resistant granules having a base material and a filler material, the base material having microorganism resistant characteristics, the filler material configured to erode over time, wherein the erosion of the filler material leaves voids and irregular surfaces in the agglomerated base material.

25. An agglomerated microorganism resistant granule comprising:
a base material having microorganism resistant characteristics; and
a filler material mixed with the base material;
the base material and filler material being sintered to form said granule;
wherein the weight of the base material compared to the weight of the granule is in a range of from about 20 percent to about 90 percent.

26. The agglomerated granule of claim 25, wherein the filler material is configured to erode over time, wherein the erosion of the filler material leaves voids and irregular surfaces in the agglomerated base material.

27. The agglomerated microorganism resistant granule of claim 26 wherein the base material is a copper alloy and the filler material is a borate material.
